(19) United States
(12) Patent Application Publication
(10) Pub. No.: US 2013/0117739 A1
(43) Pub. Date: May 9, 2013

(54) Electronic Tool for Automatically Programming a Plurality of Control Modules in a Vehicle On-Board Computer System

(71) Applicants: Paul A. Mueller, St. Clair Shores, MI (US); April D. Johnson, Canton, MI (US); Jason M. Miller, Woodhaven, MI (US); John Dolinsky, JR., Ann Arbor, MI (US); Charles H. Nagi, Livonia, MI (US); Gregory W. Farrey, Ypsilanti, MI (US); Mike Makled, Dearborn, MI (US)

(72) Inventors: Paul A. Mueller, St. Clair Shores, MI (US); April D. Johnson, Canton, MI (US); Jason M. Miller, Woodhaven, MI (US); John Dolinsky, JR., Ann Arbor, MI (US); Charles H. Nagi, Livonia, MI (US); Gregory W. Farrey, Ypsilanti, MI (US); Mike Makled, Dearborn, MI (US)

(73) Assignee: FORD GLOBAL TECHNOLOGIES, LLC, Dearborn, MI (US)

(21) Appl. No.: 13/292,306

(22) Filed: Nov. 9, 2011

(51) Int. Cl. G06F 9/44

(52) U.S. Cl. 717/169

(57) ABSTRACT

An electronic tool automatically uploads a plurality of software files into respective control modules in an on-board computer system of a vehicle. The electronic tool includes a memory having a plurality of software files stored therein that are associated with respective control modules in an on-board computer system of a vehicle. The electronic tool also includes a processor that automatically determines which ones of a plurality of individual control modules in a vehicle on-board computer system need to be programmed. In response to that determination, the electronic tool automatically uploads each of the plurality of software files into the respective control modules in the on-board computer system of the vehicle.

### BACKGROUND OF THE INVENTION

This invention relates in general to electronic tools that are used to program on-board computer systems in vehicles. In particular, this invention relates to an improved structure for such an electronic tool that automatically determines which ones of a plurality of individual control modules in a vehicle on-board computer system need to be programmed or configured, and further that automatically programs each of those particular control modules.

Most modern vehicles are provided with an on-board computer system that monitors and/or controls the operations of various sub-systems of the vehicle. A typical vehicle on-board computer system includes a plurality of individual control modules that monitor and/or control the operation of respective sub-systems of the vehicle. Some examples of known control modules that are commonly provided in a vehicle on-board computer system include a power train control module (PCM), an engine control module (ECM), a transmission control module (TCM), a body control module (BCM), and an anti-lock brake system control module (ABS).

A typical control module is a data processing device that includes a conventional processor and memory. In operation, each of the control modules receives input signals from one or more electrical components (such as sensors, for example) in the associated sub-system of the vehicle. These input signals are processed according to a software program that is stored in the memory of the control module. One or more output signals are then generated from the control module that represent the current operating status of the associated sub-system and/or control the operation of one or more other electrical components (such as actuators, for example) in the associated sub-system.

To facilitate the programming (i.e., installation or updating a software program) and configuring (i.e., the writing or individual bits and bytes to specific memory locations) of these individual control modules, it is know to provide the vehicle on-board computer system with a communication network. In some instances, the communication network consists of a communication bus that is connected to each of the control modules. In other instances, the communication network includes an interface controller that is connected to each of the control modules. The communication bus or the interface controller is also connected to an external input/output connector that is provided on the vehicle. The external input/output connector allows a conventional electronic tool to communicate with each of the control modules to, among other things, allows the electronic tool to upload a software program into the memory of the individual control module. The uploaded software program may be either an original software program (such as when the individual control module is initially programmed when the vehicle is being manufactured) or an updated version of an existing software program (such as after the vehicle has been in use).

Although known electronic tools of this general type have functioned satisfactorily, their use has been found to be relatively slow and inefficient. This is because conventional electronic tools do not determine whether an individual control module contains either an original software program or an updated version of an existing software program as described above. Furthermore, conventional electronic tools can only be used to program a single one of the individual control modules at a time. Thus, in order to program a first control module, a first software program is initially loaded into the electronic tool, then uploaded into the first control module. To program a second control module, a second software program is loaded into the electronic tool, then uploaded into the second control module. This time-consuming and laborious process is repeated for each of the subsequent individual control modules in the vehicle on-board computer system. Thus, it would be desirable to provide an improved structure for such an electronic tool that automatically determines which ones of a plurality of individual control modules in a vehicle on-board computer system need to be programmed, and further that automatically programs each of those particular control modules.

### SUMMARY OF THE INVENTION

This invention relates to an improved structure for an electronic tool that automatically determines which ones of a plurality of individual control modules in a vehicle on-board computer system need to be programmed, and further that automatically programs each of those particular control modules. The electronic tool includes a memory having a plurality of software files stored therein that are associated with respective control modules in an on-board computer system of a vehicle. The electronic tool also includes a processor that automatically determines which ones of a plurality of individual control modules in a vehicle on-board computer system need to be programmed. In response to that determination, the electronic tool automatically uploads each of the plurality of software files into the respective control modules in the on-board computer system of the vehicle.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a block diagram of a vehicle including an on-board computer system having a plurality of individual control modules and an electronic tool for automatically programming those control modules in accordance with this invention.

FIG. 2 is a flow chart of a method for operating the electronic tool illustrated in FIG. 1.

### DETAILED DESCRIPTION OF THE PREFERRED EMBODIMENT

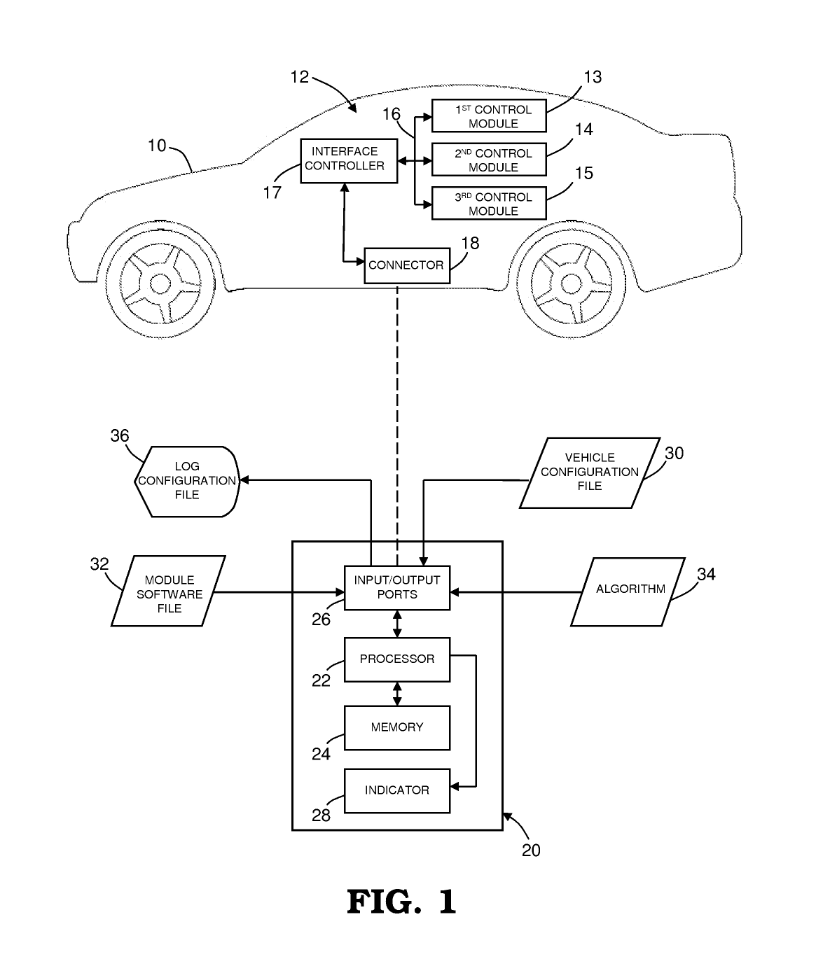

Referring now to the drawings, there is illustrated in FIG. 1 a block diagram of a vehicle, indicated generally at 10, that includes an on-board computer system, indicated generally at 12. The on-board computer system 12 is conventional in the art and includes a plurality of individual control modules, such as shown at 13, 14, and 15. Each of the control modules 13, 14, and 15 is conventional in the art and is adapted to monitor and/or control the operation of an associated sub-systems of the vehicle 10. For example, each of the control modules 13, 14, and 15 may be embodied as a conventional data processing device that includes a processor and memory (not shown). It will be appreciated that the on-board computer system 12 may include any desired number of such control modules 13, 14, and 15.

In operation, each of the control modules 13, 14, and 15 receives input signals from one or more electrical components (not shown) such as sensors, for example, provided in the associated sub-system of the vehicle 10. These input signals are processed according to a software program that is stored in the memory of the control module 13, 14, and 15. One or more output signals are then generated from the control module 13, 14, and 15 that represent the current operating status of the associated sub-system and/or control the operation of one or more other electrical components (such as actuators, for example) in the associated sub-system. Some examples of known control modules 13, 14, and 15 that are commonly provided in a vehicle on-board computer system include a power train control module (PCM), an engine control module (ECM), a transmission control module (TCM), a body control module (BCM), and an anti-lock brake system control module (ABS).

The on-board computer system 12 also includes a conventional communication network 16. In the illustrated embodiment, the communication network 16 includes an interface controller 17 that is connected to each of the control modules 13, 14, and 15. However, it will be appreciated that the interface controller 17 may be replaced by a conventional communication bus (not shown) that is connected to each of the control modules 13, 14, and 15. The on-board computer system 12 may utilize any network interface or protocol that enables communication between the control modules 13, 14, and 15 and other electronic components in the on-board computer system 12 including, for example, the conventional SAE J1850 PWM, SAE J1850 VPW, ISO 9141, ISO 14230, and ISO 15765 CAN communication protocols. The interface controller 17 (or, as mentioned above, the communication bus) is also connected to an external input/output connector 18 that is provided on the vehicle 10. The external input/output connector 18 is conventional in the art and may, for example, be embodied as an SAE International standard J1962 connector (commonly referred to as an OBDII port), a USB port, an IEEE 1394 port, or a wireless interface. The purpose for the external input/output connector 18 will be explained below.

An electronic tool, indicated generally at 20, is provided for automatically programming and/or configuring the individual control modules 13, 14, and 15 in accordance with this invention. The electronic tool 20 may be embodied as a conventional microcontroller or similar device that includes a processor 22, a memory 24, and one or more input/output ports 26. The processor 22 is capable of receiving one or more input signals, processing the input signals according to software and data stored in the memory 24, and generating one or more output signals. The memory 24 is conventional in the art and may, for example, be embodied as any type of volatile or non-volatile data storage device such as, for example, a read-only memory (ROM), an erasable programmable read-only memory (EPROM), or an electrically erasable programmable read-only memory (Flash ROM). The input/output ports 26 are configured to communicate with the processor 22 for inputting and outputting data relative to the programmable device 20. The input/output ports 26 are also conventional in the art and may, for example, be embodied as Ethernet ports, USB ports, IEEE 1394 ports, and the like.

The illustrated electronic tool 20 also includes a visual indicator 28 to provide visual feedback to a user, although such is not required. For example, the visual indicator 28 may be one or more indicator lights. Alternatively, the visual indicator 28 may be a display screen or any other component that is capable of providing visual feedback to the user. The visual indicator 28 can be connected to the processor 22 or other component of the electronic tool 20 in any manner.

As mentioned above, a variety of software and data files can be stored in the memory 24 for use by the processor 22 during operation of the electronic tool 20. In particular, the memory 24 of the electronic tool 20 includes a vehicle configuration file 30 that identifies which of the control modules are provided within any particular vehicle. To accomplish this, the vehicle configuration file 30 may include any number of conventional vehicle identification numbers (or any other desired identifying data) that are associated with a respective number of vehicles or types of vehicles. In the illustrated embodiment, the vehicle identification number of the specific vehicle 10 illustrated in FIG. 1 would represent a single one of the plurality of vehicle identification numbers provided within the vehicle configuration file 30.

Additionally, the vehicle configuration file 30 may include a plurality of lists of the control modules that are respectively associated with each of the vehicle identification numbers. Each of these lists could identify one, some, or all of the control modules in the configuration file 30 as being associated with the specific vehicle associated with the vehicle identification number. Thus, in the illustrated embodiment, the list relating to the vehicle identification number of the particular vehicle 10 illustrated in FIG. 1 would associate the three control modules 13, 14, and 15 as being provided on that vehicle 10. Accordingly, by reading the vehicle identification number of the specific vehicle 10 illustrated in FIG. 1, the processor 22 of the electronic tool 20 can determine that the three illustrated control modules 13, 14, and 15 are provided within that particular vehicle 10.

The memory 24 of the electronic tool 20 also includes a module software file 32 that is composed of a plurality of software files respectively associated with the plurality of control modules identified in the vehicle configuration file 30. Thus, the module software file 32 includes not only include the software files for the control modules 13, 14, and 15 that are provided within the specific vehicle 10 illustrated in FIG. 1, but also the software files for a variety of other control modules that may be found in other vehicles. Such software files may consist of any desired electronic data in any desired format.

The software files for all of the control modules are preferably identified by respective software part numbers. As used herein, the term “software part number” represents any desired number(s), character(s), or other indicia that associates each of the individual software files with a respective one of the plurality of control modules identified in the vehicle configuration file 30. Additionally, it is desirable that each of the software part numbers identify or otherwise be associated with a date, revision level, or other characteristic of the such software files. Accordingly, by knowing the vehicle identification number of the specific vehicle 10, the processor 22 of the electronic tool 20 can determine which of the individual software files contained in the module software file 32 relate to the specific illustrated control modules 13, 14, and 15 that are provided within the specific vehicle 10 illustrated in FIG. 1.

The memory 24 of the electronic tool 20 further includes an operating algorithm 34 that causes the electronic tool 20 to automatically determine which ones of the plurality of individual control modules in the vehicle on-board computer system 12 need to be programmed (i.e., needs either an original software program to be installed such as when the individual control module is initially programmed when the vehicle is being manufactured, or an updated version of an existing software program such as after the vehicle has been in use) and that automatically programs each of those particular control modules. The method of operation of the operating algorithm 34 will be explained in detail below.

Lastly, the memory 24 of the electronic tool 20 includes a log configuration file 36. The purpose for the log configuration file 36 will be explained below. As graphically indicated in FIG. 1, the vehicle configuration file 30, the module software file 32, the operating algorithm 34, and the log configuration file 36 can all be uploaded into and/or downloaded from the memory 14 of the electronic tool 20 by means of the input/output ports 26. Alternatively, the vehicle configuration file 30, the module software file 32, or the operating algorithm 34 can be pre-loaded into the memory 24 of the electronic tool 20 if desired.

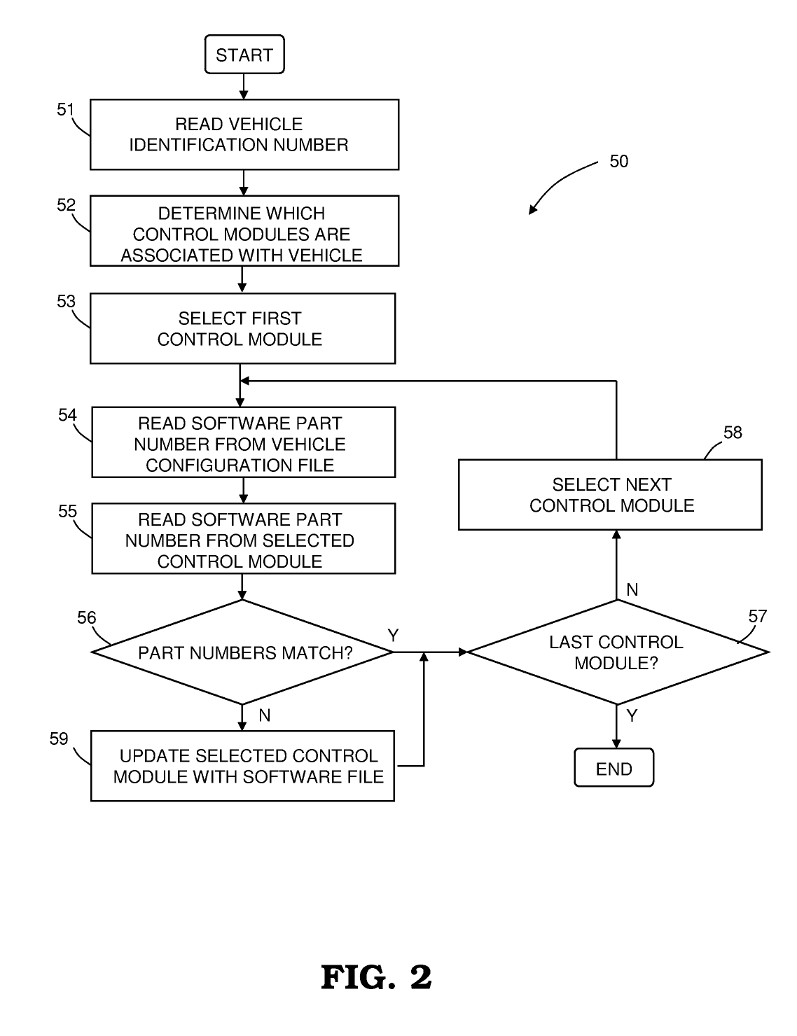

Referring now to FIG. 2, there is illustrated a flow chart of a method, indicated generally at 50, for operating the electronic tool 20 illustrated in FIG. 1. In the illustrated embodiment, the method 50 is performed by the processor 22 of the electronic tool 20 through execution of the operating algorithm 34. However, such method 50 can be performed in any other desired manner.

In an initial step 51 of the method 50, the electronic tool 20 reads the vehicle identification number (or other desired identifying data, as described above) from the vehicle 10 illustrated in FIG. 1. The vehicle identification number can be read from any desired source within the vehicle including, but not limited to, one or more of the control modules 13, 14, and 15. The electronic tool 20 may, if desired, record the date, time, and vehicle identification number of the vehicle 10 in the log configuration file 36. If the vehicle identification number is not available, the electronic tool 20 may log the date and time in the log configuration file 36, along with an indication that the vehicle identification number is not available for the specific vehicle 10. As will become apparent, this first step 51 of the method 50 can be omitted if desired.

In a second step 52 of the method 50, the electronic tool 20 determines which ones of the control modules are associated with the specifically identified vehicle 10. Preferably, this determination is made by reference to the vehicle identification number that was obtained in step 51. As discussed above, by reading the vehicle identification number of the specific vehicle 10 illustrated in FIG. 1, the processor 22 of the electronic tool 20 can determine that the three illustrated control modules 13, 14, and 15 are provided within that particular vehicle 10. However, the determination of which control modules are associated with the specifically identified vehicle can be made by any other desired means. For example, if the vehicle identification number is not available for the specific vehicle 10, the determination of which control modules are associated with that vehicle 10 can be determined by individually interrogating each of the control modules 13, 14, and 15.

Having identified which ones of the control modules 13, 14, and 15 are provided with the specific vehicle 10, the method 50 of this invention now determines whether the software files of such control modules 13, 14, and 15 need to be installed or updated. To accomplish this, the method 50 of this invention enters a third step 53, wherein the electronic tool 20 selects a first one of the control modules (such as the control module 13) from the control modules 13, 14, and 15 that were determined to be provided within the vehicle 10 in the second step 52.

Next, as shown in step 54 of the method 50, the electronic tool 20 reads the software part number of the software file that is associated with the first control module 13 from the vehicle configuration file 30. As mentioned above, each of such software part numbers is associated with a date, revision level, or other characteristic of the associated software files. Similarly, in step 55 of the method 50, the electronic tool 20 reads the software part number of the software file that is currently contained in the first control module 13 in the vehicle 10. At this point of the method 50, therefore, the software part numbers of both (1) the software file contained in the vehicle configuration file 30 and (2) the software file contained in the first control module 13 are known.

Accordingly, as shown in step 56 of the method 50, the electronic tool 20 next compares the software part number of the software file contained in the vehicle configuration file 30 with the software part number of the software file contained in the first control module 13. If the two software part numbers are the same, then the software file contained in the vehicle configuration file 30 is the same as the software file contained in the first control module 13. Accordingly, no updating of such software file is necessary. In this instance, the method 50 of this invention branches from the step 56 to a step 57, wherein a determination is made as to whether the control module that was being analyzed (the first control module 13 in this instance) represents the final one of the plurality of control modules 13, 14, and 15 contained within the specific vehicle 10. If so, then the method 50 ends. If desired, the visual indicator 28 may by energized to positively indicate that the method 50 has finished. If not, however, the method enters a step 58, wherein a next one (the second control module 14 in this instance) of the plurality of control modules 13, 14, and 15 contained within the specific vehicle 10 is selected for analysis. The method then returns to the step 54, and the above-described process for automatically updating the software file contained in the second control module 14 is repeated (if necessary).

Referring back to step 56 of the method 50, if it is alternatively determined that the two software part numbers are not the same, then the software file contained in the vehicle configuration file 30 is not the same as the software file contained in the first control module 13. Consequently, updating of such software file is necessary. In this instance, the method 50 of this invention branches from the step 56 to a step 59, wherein the software file contained in the vehicle configuration file 30 is uploaded into the first control module 13. In this manner, the software file contained in the first control module 13 is automatically updated with the software file contained in the vehicle configuration file 30. Thereafter, the method 50 branches to the step 57, wherein the determination is made as to whether the control module that was being analyzed (the first control module 13 in this instance) represents the final one of the plurality of control modules 13, 14, and 15 contained within the specific vehicle 10.

Accordingly, it can be seen that the method 50 of this invention automatically (1) identifies which ones of the individual control modules 13, 14, and 15 are provided in the vehicle on-board computer system 12, (2) determines which of those individual control modules 13, 14, and 15 need to be programmed, and (3) automatically programs each of those individual control modules 13, 14, and 15 with the appropriate software files contained within the module software file 32.

If desired, the electronic tool 20 may log the date, time, and the software part numbers that have been successfully programmed in the log configuration file 36. This can be done at any desired point in the method 50 of this invention. Furthermore, if there is a failure with such programming at any point in the method 50 time, then the electronic tool 20 may log an error message in the log configuration file 36. Also, the electronic tool 20 may record any conventional diagnostic trouble codes in the log configuration file 36. It will be appreciated that the log configuration file 36 can be provided in any format, such as a visual display, an electronic file, or in hard-copy form.

Referring back to FIG. 1, The principle and mode of operation of this invention have been explained and illustrated in its preferred embodiment. However, it must be understood that this invention may be practiced otherwise than as specifically explained and illustrated without departing from its spirit or scope.

What is claimed is:

1. An electronic tool for automatically uploading a plurality of software files into respective control modules in an on-board computer system of a vehicle comprising:
a memory having a plurality of software files stored therein that are associated with respective control modules in an on-board computer system of a vehicle; and
a processor that automatically uploads each of the plurality of software files into the respective control modules in the on-board computer system of the vehicle.

2. The electronic tool defined in claim 1 wherein each of the plurality of software files stored in the memory is associated with a software part number, and wherein the processor compares the software part numbers of the software files stored in the memory with software part numbers of software files stored in the control modules.

3. The electronic tool defined in claim 1 wherein the processor initially determines which control modules in the vehicle on-board computer system need to be programmed and subsequently automatically uploads only the software files corresponding to the determined control modules in the on-board computer system of the vehicle.

4. The electronic tool defined in claim 1 wherein the memory includes a vehicle configuration file that identifies which control modules are provided within a particular vehicle.

5. The electronic tool defined in claim 4 wherein the vehicle configuration file includes (1) a plurality of vehicle identification numbers or other identifying data that are associated with a respective number of vehicles or types of vehicles.

6. The electronic tool defined in claim 5 wherein the vehicle configuration file further includes a plurality of lists of the control modules that are respectively associated with each of the vehicle identification numbers.

7. The electronic tool defined in claim 4 wherein the memory includes a module software file that includes a plurality of software files respectively associated with the control modules identified in the vehicle configuration file.

8. The electronic tool defined in claim 1 further including one or more input/output ports connected to the processor.

9. A method for automatically uploading a plurality of software files into respective control modules in an on-board computer system of a vehicle comprising the steps of:
(a) determining which of a plurality of control modules are associated with a vehicle;
(b) determining whether software files respectively contained within each of the plurality of control modules need to be programmed; and
(c) automatically uploading software files into each of the plurality of control modules that need to be programmed.

10. The method defined in claim 9 wherein step (a) is performed by reading a vehicle identification numbers or other identifying data that are associated with a vehicles and determining which of the plurality of control modules are associated with the vehicle identification number or other identifying data.

11. The method defined in claim 9 wherein step (b) is performed by comparing a software part number of a software file contained in a control module is the same as a software part number of a software file contained in a vehicle configuration file.

12. The method defined in claim 11 wherein step (c) is performed when the software part number of the software file contained in the control module is not the same as the software part number of the software file contained in the vehicle configuration file.
